(19) United States
(12) Patent Application Publication
(10) Pub. No.: US 2024/0332524 A1
(43) Pub. Date: Oct. 3, 2024

(54) MANUFACTURING OF CORE-SHELL ELECTRODE MATERIALS FOR SOLID-STATE BATTERIES AND SYSTEMS AND METHODS OF THE SAME

(71) Applicant: Ampcera Inc., Milpitas, CA (US)

(72) Inventors: Eongyu Yi, Tucson, AZ (US); James Emery Brown, Tucson, AZ (US); Hui Du, Tucson, AZ (US); Sumin Zhu, Tucson, AZ (US)

(73) Assignee: Ampcera Inc., Milpitas, CA (US)

(21) Appl. No.: 18/618,050

(22) Filed: Mar. 27, 2024

Related U.S. Application Data
(60) Provisional application No. 63/455,440, filed on Mar. 29, 2023.

(51) Int. Cl. H01M 4/525; H01M 4/02; H01M 4/04; H01M 4/131; H01M 4/36

(52) U.S. Cl. CPC H01M 4/525; H01M 4/0419; H01M 4/131; H01M 4/366; H01M 2004/021; H01M 2004/027; H01M 2004/028

(57) ABSTRACT

A method for manufacturing a core-shell material comprises: atomizing a feedstock comprising a mixture of an active material and a solid-state ionic conductive material, or precursors thereof; and drying the atomized feedstock to form a core-shell material, the core-shell material comprising a core comprising the active material; and a coating of the solid-state ionic conductive material on the core to form a shell in intimate contact with the core.

### PRIORITY

This application claims priority from U.S. Ser. No. 63/455,440 filed on Mar. 29, 2023, the entire contents of which are incorporated herein by reference.

### FIELD

The present application pertains to the field of advanced electrode materials specifically designed for solid-state batteries and other end-use applications.

### BACKGROUND

Conventional lithium-ion batteries that use liquid electrolytes have been widely adopted in various applications, such as electric vehicles and portable electronics. However, there are safety concerns associated with these batteries, including the risk of thermal runaway, fires, and explosions, primarily due to the volatile and flammable nature of liquid electrolytes. Solid-state batteries have the potential to overcome these safety concerns, as they utilize solid-state electrolytes, which can provide enhanced thermal and electrochemical stability.

Despite the advantages of solid-state batteries, achieving optimal performance remains challenging. One of the key issues is the ionic conduction within the battery. In conventional lithium-ion batteries, liquid electrolytes facilitate good ionic conduction owing to continuous fluidic contact with active battery materials. However, solid-state electrolytes require intimate contact between active battery materials and solid-state ionic conductive materials to ensure sufficient ionic conduction. This close contact is important for maintaining efficient charge transfer and overall battery performance.

Additionally, solid-state batteries may experience higher interfacial impedance and slower lithium diffusion kinetics, which can result in reduced power output and energy density. Therefore, there is a continuous need for research and development in the field of electrode materials for solid-state batteries, as well as innovative methods for manufacturing these materials. Improved electrode materials and manufacturing techniques can potentially address the challenges related to ionic conduction, interfacial impedance, and lithium diffusion kinetics, ultimately contributing to the development of safer and more efficient solid-state batteries.

### SUMMARY

The present description relates to core-shell materials that may be used for solid-state batteries, methods for manufacturing the core-shell materials, methods for manufacturing structures using the core-shell materials, and structures manufactured using the core-shell materials.

The core-shell materials comprise core comprising an active material and a solid-state ionic conductive material shell. The active material core forms the core of the core-shell materials. The active material may include, but is not limited to, lithium-based or other metal-based materials, such as transition metal oxides, sulfides, or phosphates, which function as the primary electrochemically active components in the battery. These materials undergo reversible lithium-ion (or other metal-ion) insertion and extraction processes during the charge and discharge cycles of the battery, allowing for the storage and release of electrical energy. The active material may include, for example, an active cathode material or an active anode material. The active cathode material may comprise, for example, lithium cobalt oxide (LiCoO₂), lithium manganese oxide (LiMn₂O₄), lithium iron phosphate (LiFePO₄), or other mixed-metal oxides. The active anode material may comprise, for example, lithium metal, lithium alloys, silicon, tin, or carbon-based materials such as graphite or hard carbon.

The solid-state ionic conductive material forms the shell surrounding the active material core. This material may include various solid-state electrolytes, such as lithium-ion conductive ceramics (e.g., garnet-type materials like Li₇La₃Zr₂O₁₂), glasses (e.g., Li₂S—P₂S₅ or Li₂S—SiS₂), or glass-ceramics, which allow for the transport of lithium ions (or other metal ions) between the electrodes of the battery without the need for a liquid electrolyte.

The core-shell materials possess a core-shell structure, wherein the active material core is partially or fully encapsulated by the solid-state ionic conductive material shell. This core-shell structure allows for intimate contact between the active core and the solid-state ionic conductive shell.

The core-shell structures may enhance contact between the active core and solid-state ionic conductive shell, reducing interface impedance, and enabling higher power rates in solid-state batteries. The core-shell structures enhance contact between the active core and solid-state ionic conductive shell by providing a coating of the solid-state ionic conductive material around the surface of the active core. This ensures a high contact surface area between the active core and the solid-state electrolyte, creating a consistent and continuous pathway for ionic transport. Enhanced contact between the active core and the solid-state ionic conductive shell may reduce interface impedance and enables higher power rates in solid-state batteries for several reasons. First, the coating of the solid-state ionic conductive shell around the active core may reduce the number of potential barriers for lithium-ion transport at the interface, improving the overall ionic conductivity. Second, the intimate contact between the active core and the solid-state ionic conductive shell may minimize the formation of any unwanted passivation layers or interfacial films that could increase impedance and hinder ionic transport. Third, the improved contact between the active core and the solid-state ionic conductive shell may ensure that the lithium-ion transport occurs efficiently across the entire interface, resulting in a more uniform and rapid charge/discharge process, which contributes to higher power rates in solid-state batteries.

The architecture of the core-shell structure may compensate or accommodate the volume change of the active core material during lithium insertion/extraction, preventing material contact loss and enhancing cycle life. The active core material changes volume during lithium insertion/extraction due to the intercalation or deintercalation of lithium ions within the crystal lattice of the active material, causing a corresponding expansion or contraction of the lattice structure. The core-shell architecture may help accommodate these volume changes in several ways. For example, the solid-state ionic conductive shell surrounding the active core may have a degree of flexibility or elasticity, allowing it to expand or contract with the active core material while maintaining intimate contact. This ensures that the ionic transport pathway remains continuous during cycling. By compensating or accommodating the volume change of the active core material, the core-shell architecture helps to prevent material contact loss, as the intimate contact between the active core and the solid-state ionic conductive shell is maintained throughout the battery's operation. This continuous contact enables efficient ionic transport between the active core material and the solid-state electrolyte, reducing interfacial impedance and ensuring stable performance. As a result, the core-shell structure contributes to an enhanced cycle life for the solid-state battery, as the performance of the active material remains consistent, and the mechanical integrity of the core-shell structure is preserved over multiple charge and discharge cycles.

The core-shell structures may have a small size, reducing lithium diffusion kinetics, and further enabling higher-power rates in solid-state batteries. The size refers to the maximum dimensions of the core-shell structure. There may be several reasons why small size enables higher-power rates in solid-state batteries. First, the reduced size of the core-shell structures may result in shorter diffusion pathways for lithium ions to travel between the active core and the solid-state ionic conductive shell. This enables faster lithium-ion transport, leading to faster charge and discharge rates. Second, the sub-micron size may increase the surface area-to-volume ratio of the core-shell structures, which facilitates greater contact between the active core and the solid-state ionic conductive shell. This enhanced contact improves ionic conductivity, further contributing to higher power rates. Lastly, the smaller dimensions of the core-shell structures may also provide better packing within the electrode, resulting in higher energy density and improved electrochemical performance of the solid-state batteries.

The core of the core-shell materials may include a protective layer on the active material. The protective layer may form a thin, conformal coating surrounding the active material, ensuring a uniform and continuous coverage. The protective layer may comprise materials such as, for example, lithium borate, lithium aluminate (LiAlO₂), lithium tungstate (Li₂WO₄), lithium niobium oxide (LiNbO₃), lithium phosphate (Li₃PO₄), lithium oxysulfide (LiAlSO, Li₃PO₄—Li₂S—SiS₂), or lithium oxynitride (LiPON). The protective layer may serve to prevent adverse reactions between the active material and the solid-state electrolyte, particularly in instances where high voltages are required but the electrochemical stability window of the solid-state electrolyte is insufficient. By isolating the active material from possible reactions, the protective layer helps maintain the integrity and performance of the core-shell material and the overall solid-state battery.

The core-shell materials may be manufactured by various manufacturing processes, such as by way of a spray process, including spray pyrolysis, spray drying, or other spray techniques. A spray process may involve atomizing a feedstock slurry containing active core material particles and solid-state ionic conductive material, followed by drying the resulting droplets to form core-shell structures. The spray process may include spray pyrolysis. Spray pyrolysis may involve atomizing the feedstock slurry and introducing the atomized droplets into a high-temperature environment, causing the solvent to evaporate and the precursor materials to undergo chemical reactions, thereby forming the core-shell structures. The spray process may include spray drying. Spray drying may involve atomizing the feedstock slurry and introducing the atomized droplets into a drying chamber with hot gas or air, causing the solvent to evaporate and leaving behind the solid core-shell structures. Other spray processes may include electrostatic spray deposition, ultrasonic spray deposition, or other techniques suitable for forming core-shell structures. In a specific embodiment of a manufacturing process, a feedstock slurry containing active core material particles may be nebulized, such as by pumping the feedstock slurry into a spray nozzle comprising a nebulizer. The nebulized mist may be dried, thus forming the core-shell structure, such as by spraying the nebulized mist into a high-temperature drying chamber, which may then be collected. The collected core-shell structures may be used for solid-state battery production or other applications.

The feedstock for the manufacturing process may comprise of active battery materials and solid-state ionic conductive materials, or precursors thereof. In an embodiment, the feedstock includes a mixture of active battery materials suspended in a solvent, along with solid-state ionic conductive materials or precursors dissolved therein. In one aspect of the continuous manufacturing method, a slurry-based feedstock solution containing active battery materials and solid-state ionic conductive precursors is created. The precursors, which could include materials like phosphorus pentasulfide, lithium sulfide, or lithium chloride, are used to form a solid-state ionic conductive shell around the active core. The solvent in the feedstock may comprise various organic solvents or a mixture thereof. The manufacturing process involves pumping the feedstock solution through a feeding line and into a spray nozzle with a nebulizer, which atomizes the solution into a fine mist. This mist is then sprayed into a high-temperature drying chamber using a high-pressure hot inert gas. The drying chamber, with a temperature range of 50≤T≤2000° C., evaporates the solvent and anneals the precursor materials into a shell around the active electrode materials. The evaporated solvent may be removed from the chamber, condensed, and reused. Core-shell materials may be collected at the bottom of the chamber through gravity sedimentation and passed into a collection chamber. The inert gas, carrying unreacted precursors and fine or sub-micron core-shell materials, may be forced out through an air outlet and into a cyclone separator, which classifies and collects the fine core-shell structures from the gas mixture. The gas may then be filtered to remove any remaining unreacted precursors and exhausted. The exhausted gas can be returned to the heating system for reuse.

The core-shell materials may enhance contact between the core and shell, which may reduce interface impedance and enable higher power rates in solid-state batteries. The core-shell structures may reduce lithium diffusion kinetics and further enable higher power rates. Moreover, the core-shell architecture may accommodate the volume change of the active core material during lithium insertion/extraction, preventing material contact loss and enhancing the cycle life of solid-state batteries.

The methods for manufacturing structures using core-shell materials may involve various processes. These methods typically require providing a core-shell material and depositing the core-shell material onto a substrate. Deposition methods can be categorized based on the nature of the process, such as solvent-based, binder-based, or binder-free processes. Solvent-based deposition methods use a solution or suspension of core-shell materials in a solvent to facilitate deposition onto the substrate. Examples of solvent-based processes include spin coating, dip coating, spray coating, doctor blade coating, slot-die coating, and roll-to-roll coating. Binder-based deposition methods use a mixture of core-shell materials and a binder, which acts as a binding agent, to form a paste or slurry suitable for deposition. Examples of binder-based processes include screen printing and inkjet printing. Alternatively, a binder-based deposition method is a dry-processing which may include hot calendering. Binder-free deposition methods do not require the use of binders or solvents during deposition. These processes typically involve the direct application of core-shell materials onto a substrate. Examples of binder-free processes include cold spray and thermal spray.

The structures manufactured using core-shell materials may involve various configurations, including layered structures composed of multiple functional layers. One such layered structure may feature a layer formed from a core-shell material, designed to enhance the performance of the overall structure. In a specific embodiment, a solid-state battery can be constructed using a layered configuration, which may include: an electron-conducting layer; a solid-state electrolyte layer; and a counter-electrode layer. The electron-conducting layer comprises a core-shell material, where the core consists of an active electrode material (cathode or anode), and the shell is made of a solid-state ionically conductive material. The core-shell structure enhances the electrical conductivity and stability of the electrode while maintaining effective ionic transport. The solid-state electrolyte layer is responsible for the transport of lithium ions between the anode and cathode. It is typically made of a solid-state ionically conductive material with high lithium-ion conductivity and excellent mechanical and electrochemical stability. The counter electrode layer serves as the opposite electrode to the electron-conducting layer containing the core-shell material. It can be either the anode or cathode, depending on the specific configuration. The counter electrode layer may also be composed of core-shell materials or other suitable active electrode materials. The layered design of the solid-state battery, incorporating core-shell materials, provides improved performance by optimizing electron and ion transport, enhancing interface stability, and enabling higher power rates. Alternatively, a counter electrode includes a current collector which is commonly referred to in the art as an anodeless solid-state batter.

Solid-state batteries incorporating the core-shell structures can be employed in a wide range of battery designs and end-use applications. These applications include, but are not limited to, electric vehicles, portable electronics, grid-scale energy storage, renewable energy storage systems, aerospace applications, wearable devices, and medical devices. The core-shell structures enhance the performance of these batteries, leading to improved energy density, power output, and cycle life. In addition to battery applications, the core-shell structures can also be utilized in non-battery applications, such as lithium extraction from natural resources, lithium recovery from brines or seawater, and recycling of spent batteries. For instance, a composite solid-state electrolyte layer, comprising a core-shell structure, may be used as a selective membrane or separation layer to extract lithium from lithium-containing solutions, increasing the efficiency and sustainability of lithium mining processes. Similarly, the core-shell structures can facilitate the recovery of valuable materials from spent batteries during recycling processes. By incorporating core-shell materials in the treatment and separation stages, enhanced selective extraction and recovery of electrode materials, electrolytes, and other valuable components can be achieved, contributing to a more sustainable and circular battery economy.

### BRIEF DESCRIPTION OF THE DRAWINGS

FIG. 1 illustrates the process for manufacturing core-shell materials, from mixing the feedstock to atomizing and drying it in a high-temperature chamber, culminating in the collection of core-shell structures.

FIG. 2 provides a close-up view of a core-shell structure, showing the active material core encapsulated by the solid-state ionic conductive shell.

FIG. 3 displays a solid-state battery configuration, detailing layers composed of composite cathode and anode layers separated by a solid-state electrolyte layer, all incorporating core-shell materials.

FIG. 4 focuses on a lithium metal battery variant, highlighting the use of a metal or metal alloy film in place of a composite anode layer and illustrating the inclusion of core-shell materials in the cathode.

FIG. 5 shows an anodeless solid-state battery design, emphasizing a composite cathode layer with core-shell structures directly applied to a positive current collector, illustrating a lightweight and high-energy-density battery setup.

### DETAILED DESCRIPTION

The present description relates to core-shell electrode materials that may be used for solid-state batteries and methods for manufacturing, preferably continuous manufacturing of core-shell electrode materials. A continuous manufacturing method may include, for example, a spray process, such as spray pyrolysis, spray drying, or other spray techniques.

Solid-state batteries can negate the safety concerns associated with conventional lithium-ion batteries. But replacing the role of liquid electrolytes requires intimate contact between active battery materials and solid-state ionic conductive materials for sufficient ionic conduction to occur. Furthermore, the solid electrolyte powder should be uniformly distributed within the electrode layers to provide superior ion transport. By forming the solid electrolyte material directly onto the active material, both the highest form of intimate contact and mixing uniformity can be achieved.

The present description also relates to a core-shell cathode material for a solid-state battery, wherein the core is composed of an active cathode material and the shell is composed of a solid-state ionic conducting material.

The present description also relates to a core-shell anode material for a solid-state battery, wherein the core is composed of an active anode material and the shell is composed of a solid-state ionic conducting material.

In an embodiment, a core-shell structure may comprise an active battery material core and a solid-state ionic conductive shell for solid-state batteries.

In another embodiment, a spray processing approach, such as spray pyrolysis, spray drying, or other spray techniques, may be used for the continuous manufacturing of core-shell electrode materials for solid-state batteries.

In an aspect of the embodiment, a feedstock may comprise a slurry comprising of one or more active battery materials dispersed in a solvent system and solid-state ionic conductor precursor materials dissolved or dissociated within.

In another aspect of the embodiment, a feedstock may be sprayed into a high-temperature drying chamber wherein it is nebulized into a fine mist using a nebulizer also referred to in the art as an atomizer. Mist droplets may comprise one or more active battery materials and dissolved or dissociated solid-state ionic conductor precursor materials.

In yet another aspect of the embodiment, a high-temperature drying chamber may be used to rapidly evaporate the solvent and anneal the precursor materials into a solid-state ionic conductor shell around the active battery material, forming a core-shell structure.

In yet another aspect of the embodiment, the core-shell structures may be collected and used in the downstream manufacturing of solid-state batteries.

In yet another embodiment, a core-shell structure may be a core-shell cathode material for solid-state batteries, wherein the solid-state ionic conductive shell serves as the catholyte.

In an aspect of the embodiment, a core material may include, preferably, LiNiₓCo_{y}Mn_{z}O₂, where x is in the range of 0.99≥x≥0.5, y is in the range of 0.3≥y≥0.005, and z is in the range of 0.2≥z≥0.005.

In another aspect of the embodiment, core may include a protective layer. The active material may be coated with a thin protective layer before the continuous manufacturing process of the core-shell structure commences. This protective layer may serve as a barrier between the active material and the solid-state ionic conductive shell, preventing undesired side reactions and enhancing the stability of the active material during the manufacturing process and the operation of the battery. The protective layer can be made from various materials, such as metal oxides, nitrides, phosphates, or other suitable compounds, depending on the specific requirements of the core material and the application. This thin protective layer may also improve the adhesion between the core and the ionic conductive shell, promoting better contact and reducing the interface impedance for improved performance. The coating process can be achieved through different techniques, such as atomic layer deposition (ALD), chemical vapor deposition (CVD), or other appropriate methods, to ensure a uniform and conformal coating of the protective layer onto the active core material.

In yet another aspect of the embodiment, a solid-state ionic conductive shell may include, preferably, argyrodite with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another embodiment, a core-shell structure may be a core-shell anode material for solid-state batteries, wherein the solid-state ionic conductive shell serves as the anolyte.

In an aspect of the embodiment, a core material may include, preferably, silicon, graphite, or a combination thereof.

In another aspect of the embodiment, a solid-state ionic conductive shell may include, preferably, argyrodite with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another embodiment, the continuous manufacturing of the core-shell structures using a spray pyrolysis approach may enhance the performance of solid-state batteries.

In an aspect of the embodiment, an intimate contact is formed between the active core and solid-state ionic conductive shell. The intimate contact between the active core and solid-state ionic conductive shell refers to the close and continuous interaction between the two materials at their interface. This close contact is achieved through the core-shell architecture, where the solid-state ionic conductive shell is deposited onto the surface of the active core material, maximizing the contact area between the two materials. The intimate contact can be further enhanced by selecting suitable materials for the core and shell, which have good chemical and mechanical compatibility, as well as optimizing the manufacturing process to create a uniform and continuous shell layer. The intimate contact reduces interfacial impedance by minimizing the resistance to ion transport across the interface between the active core and the solid-state ionic conductive shell. When the interface impedance is reduced, ions can move more freely between the core and the shell, allowing for faster charge and discharge processes in the solid-state battery. This results in higher power rates and improved overall performance of the battery. Moreover, the intimate contact may also reduce the likelihood of the formation of interfacial layers or passivation films that can further impede ion transport and degrade battery performance.

In another aspect of the embodiment, the spray pyrolysis approach offers advantages for the formation of uniform shells onto active cores. During spray pyrolysis, the active core particles are dispersed in a precursor solution, which is then atomized into fine droplets. These droplets are subsequently exposed to high temperatures, causing the precursor solution to evaporate and react, resulting in the deposition of a uniform and conformal solid-state ionic conductive shell layer onto the active core particles. This uniform shell formation is advantageous for reducing lithium diffusion kinetics, as it creates a continuous and consistent pathway for lithium ions to travel through the solid-state ionic conductive shell. With a uniform shell, there are fewer barriers or discontinuities that can impede ion transport, allowing for more efficient lithium diffusion. This improved lithium diffusion, in turn, contributes to higher power rates for the solid-state battery, as it enables faster charge and discharge processes. Additionally, the spray pyrolysis process is highly controllable and scalable, allowing for the optimization of shell thickness, composition, and morphology, further contributing to the enhancement of battery performance.

In yet another aspect of the embodiment, the core-shell structure is designed to address the volume change issue that may arise in active core materials during the lithium insertion/extraction process. As lithium ions are inserted into or extracted from the active core material, they can undergo significant volume expansion or contraction. This volumetric change can lead to mechanical stress, which may cause material degradation or loss of contact between the active core material and the solid-state ionic conductive shell. The core-shell architecture is beneficial in this regard, as it allows the solid-state ionic conductive shell to act as a buffer, compensating for or accommodating the volume change of the active core material during lithium insertion/extraction. The shell material may conform to the changing volume of the active core while maintaining good contact with the active core material throughout the charge and discharge cycles. This maintained contact between the active core and the solid-state ionic conductive shell helps prevent material contact loss, which enables efficient lithium-ion transport and overall battery performance. As a result, the core-shell architecture may contribute to an enhanced cycle life for the solid-state battery, as it mitigates the negative effects of volume change during cycling and helps maintain stable electrochemical performance over an extended period.

The present disclosure relates to a core-shell electrode material for solid-state batteries.

A core-shell electrode material may comprise of an active material core and a solid-state ionic conductive shell.

An active material core may include an active cathode material or active anode material.

The present description relates to an active cathode core.

An active cathode core material may include, preferably, LiNiₓCo_{y}Mn_{z}O₂, where x is in the range of 0.99≥x≥0.1, y is in the range of 0.3≥y≥0.005, and z is in the range of 0.2≥z≥0.005.

Alternatively, an active cathode material may include, for example, layered YMO₂, Y-rich layered Y₁₊ₓM₁₋ₓO₂, spinel YM₂O₄, olivine YMPO₄, silicate Y₂MSiO₄, borate YMBO₃, tavorite YMPO₄F (where M is Fe, Co, Ni, Mn, Cu, Cr, etc.), (where Y is Li, Na, K, Mg, Zn, Al, etc.), vanadium oxides, sulfur, lithium sulfide FeF₃, LiSe.

In the case of lithium intercalation, cathodes may include, for example, lithium iron phosphate (LiFePO₄), lithium cobalt oxide (LiCoO₂), lithium manganese oxide (LiMn₂O₄), and lithium nickel oxide (LiNiO₂), lithium nickel cobalt aluminum oxide (LiNiₓCo_{y}Al_{z}O₂, 0.95≥x≥0.5, 0.3≥y≥0.025, 0.2≥z≥0.025), lithium nickel manganese spinel (LiNi_{0.5}Mn_{1.5}O₄), etc.

An active cathode material may be coated with a protective layer prior to the manufacturing of the core-shell structure to prevent reactions between the catholyte, wherein a high voltage is needed but the electrochemical window is not sufficiently expanded. Protective layers may be composed of, for example, lithium borate, lithium aluminate (LiAlO₂), lithium tungstate (Li₂WO₄), lithium niobium oxide (LiNbO₃), lithium phosphate (Li₃PO₄), lithium oxysulfide (LiAlSO, Li₃PO₄—Li₂S—SiS₂), lithium oxynitride (LiPON), etc.

An active cathode core material may have a particle in the range of 1≤d≤100,000 nm, with a preferred range of 10≤d≤25,000 nm, including sub-ranges of 10≤d≤1,000 nm, 1,000≤d≤10,000 nm, and 10,000≤d≤25,000 nm.

The present description relates to an active anode core.

An active anode core material may include, preferably, silicon, graphite, or a combination thereof. A silicon anode core material may be n-doped or p-doped.

Alternatively, an active anode material may include, for example, titanate, lithium powder, titanium oxide, tin, tin oxide, germanium, antimony, silicon oxide, iron oxide, cobalt oxide, ruthenium oxide, molybdenum oxide, molybdenum sulfide, chromium oxide, nickel oxide, manganese oxide, carbon-based materials (hard carbons, soft carbons, graphene, graphite's, carbon nanofibers, carbon nanotubes, etc.). One or more of these alternative materials may be in combination with a preferred silicon or graphite active material in the anode later of a solid-state battery.

An active anode material may be coated with a protective layer composed of, for example, lithium borate, lithium aluminate (LiAlO₂), lithium tungstate (Li₂WO₄), lithium niobium oxide (LiNbO₃), lithium phosphate (Li₃PO₄), lithium oxysulfide (LiAlSO, Li₃PO₄—Li₂S—SiS₂), lithium oxynitride (LiPON), etc.

An active anode core material may have a particle in the range of 1≤d≤100,000 nm, with a preferred range of 10≤d≤25,000 nm, including sub-ranges of 10≤d≤1,000 nm, 1,000≤d≤10,000 nm, and 10,000≤d≤25,000 nm.

The present description relates to a solid-state ionic conductive shell.

A solid-state ionic conductive shell is composed of a solid-state ionic conductive material.

A solid-state ionic conductive material is a type of material that can selectively allow a specific charged element to pass through under the presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include for example H⁺, Li⁺, Na⁺, K⁺, Ag⁺, Mg²⁺, Zn²⁺, Al³⁺, Fe³⁺, etc.

The ionic conductivity of the corresponding ions is preferably to be >10⁻⁷ S/cm. It is preferable to have lower electronic conductivity (<10⁻⁷ S/cm).

A solid-state ionic conductive material may include, preferably, argyrodite with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

Alternative examples of a solid-state ionic conductive material include, for instance, a garnet-like structure oxide material with the general formula:

Liₙ[A_{(3-a′-a″)}A′(a′)A″(a″)][B_{(2-b′-b″)}B′(b′)B″(b″)][C′(c′)C″(c″)]O₁₂,
a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and
d. wherein n=7+a′+2·a″−b′−2·b+″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium conductor, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆ (H=F, Cl, Br, I) family of materials, Y can be replaced by other rare earth elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials the general formula: Li₁₈₋₂ₘ₋ₓ(M₂^{m+}Y₇²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=Q²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A solid-state ionically conductive shell may have an average thickness in the range of 1≤t≤100,000 nm, with a preferred range of 10≤t≤10,000 nm, including sub-ranges of 10≤t≤100 nm, 1000≤t≤1,000 nm, and 1,000≤t≤10,000 nm.

The core-shell structure may have a thickness-to-core size ratio (R) defined as the shell thickness (t) divided by the core size (d). This ratio can be in the range of 0.000001≤R≤100,000, with a preferred range of 0.001≤R≤100, with a more preferred range of 0.01≤R≤10, including sub-ranges of 0.01≤R≤0.1, 0.1≤R≤1, 1≤R≤5, and 5≤R≤10, where a smaller ratio indicates a thinner shell relative to the core size, and a larger ratio indicates a thicker shell relative to the core size.

The present disclosure relates to a continuous manufacturing method for core-shell electrode materials.

In an aspect of the continuous manufacturing method, a continuous process may include a spray pyrolysis or spray dry process.

In another aspect of the continuous manufacturing method, a slurry-based feedstock solution may comprise active battery materials suspended in a solvent and solid-state ionic conductive precursors dissolved or dissociated within.

In an example, a precursor may include an inorganic compound with the general formula A₂Y where A is lithium (Li), sodium (Na), potassium (K), cesium (Cs), or rubidium (Rb), and Y is sulfur (S), selenium (Se), or tellurium (Te).

In an example, a precursor may include an alkali-metal halide salt with the general formula AX where A is lithium (Li), sodium (Na), potassium (K), cesium (Cs), or rubidium (Rb), and X is fluorine (F), chlorine (Cl), bromine (Br), or iodine (I).

In an example, a precursor may include an inorganic compound with the empirical formula M_{y}^{m+}Yₘ^{y-} where M^{m+} is boron (B³⁺), gallium (Ga³⁺), antimony (Sb³⁺), silicon (Si⁴⁺), germanium (Ge⁴⁺), tin (Sn⁴⁺), phosphorus (P⁵⁺), or arsenic (As⁵⁺) and Y^{y-} is sulfur (S²⁻), selenium (Se²⁻), or tellurium (Te²⁻)

In an example, precursors may be used to form an argyrodite-based solid-state ionic conductive shell around the active core. Precursors may include, for example, phosphorus pentasulfide, lithium sulfide, lithium fluoride, lithium chloride, lithium bromide, lithium iodide, etc. Precursors for other solid-state ionic conductive shells may be apparent to those skilled in the art.

A solvent may include, for example, ethyl acetate, propyl acetate, isopropyl acetate, butyl acetate, tetrahydrofuran, acetonitrile, hydrazine, methanol, ethanol, propanol, hexane, cyclohexane, toluene, xylenes, etc., or a mixture thereof.

A slurry-based feedstock may further comprise of surfactants to aid in particle dispersion.

In yet another aspect of the continuous manufacturing method, a slurry-based feedstock solution may be pumped through a feeding line and into a shower head or spray nozzle comprising of a nebulizer. A nebulizer may be used to atomize the feedstock solution into a fine mist.

In yet another aspect of the continuous manufacturing method, a shower nozzle or spray nozzle may spray the fine mist into a high-temperature drying chamber using high-temperature inert gas under sufficient pressure. A high-pressure hot inert gas may be delivered to the shower head or spray nozzle from a heating system. Delivery pressure may be in the range of 1≤P≤100,000 pounds per square inch. An inert gas may include nitrogen, argon, helium, neon, or xenon.

A high-temperature drying chamber may be used to evaporate the solvent while preferably simultaneously annealing the precursor materials into a shell around the active electrode materials. Examples of high-temperature drying chambers include, but are not limited to, rotary kilns, tube furnaces, muffle furnaces, spray dryers equipped with high-temperature heating capabilities, and fluidized bed reactors. These high-temperature drying chambers can be operated under various conditions, such as inert or reducing atmospheres, and may have a temperature in the range of 50≤T≤2000° C.

The evaporated solvent may be pushed out of the chamber, condensed, and reused as part of the continuous manufacturing method.

In yet another aspect of the continuous manufacturing method, the core-shell materials may be collected at the bottom of the chamber through gravity sedimentation and passed through a collection line and into a collection chamber.

In yet another aspect of the continuous manufacturing method, the inert gas may be forced out through an air outlet and into a cyclone separator. The inert gas may carry out unreacted precursor materials and fine or sub-micron-sized core-shell materials that are too small to be easily collected at the bottom of the chamber by gravity sedimentation.

A cyclone separator may be used to classify and collect the fine or sub-micron-sized core-shell structures from the gas mixture.

In yet another aspect of the continuous manufacturing method, the gas may be passed through a filter to collect the unreacted precursors and exhausted. The exhausted gas may be returned to the heating system and reused.

The present disclosure relates to a solid-state battery comprising core-shell electrode materials formed through a continuous manufacturing process.

A solid-state battery may comprise a composite cathode layer, a composite anode layer, and a solid-state electrolyte layer.

The present description relates to a composite cathode layer.

A composite cathode layer may comprise one or more core-shell structures.

A composite cathode layer may comprise core-shell structures with all of the same active cathode material, preferably with the general formula LiNiₓCo_{y}Mn_{z}O₂, where x is in the range of 0.99≥x≥0.1, y is in the range of 0.3≥y≥0.005, and z is in the range of 0.2≥z≥0.005.

Alternatively, a composite cathode layer may comprise of core-shell structures of varying active cathode cores.

A composite cathode layer may comprise of core-shell structures all of the same shell material, preferably with the general formula Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

Alternatively, a composite cathode layer may comprise of core-shell structures of varying shell materials.

A composite cathode layer may be formed onto a positive current collector. A positive current collector may include, for example, aluminum foil, nickel foil, etc.

A composite cathode layer may include an electronically conductive additive such as, for example, graphene, reduced graphene oxide, carbon nanotubes, carbon black, vapor grown carbon fibers, Super P, acetylene black, carbon nanofibers, etc. Alternatively, an electronically conductive additive may include an electronically conductive polymer such as, for example, polyaniline, polypyrrole, poly(3,4-ethylenedioxythiophene (PEDOT), polyphenylene vinylene etc.

A composite cathode layer may include a polymer binder or binder agent to bind it to the positive current collector.

The present description relates to a composite anode layer.

A composite anode layer may comprise of one or more core-shell structures.

A composite anode layer may comprise of core-shell structures all of the same active anode material, preferably silicon, graphite, or lithium powder.

Alternatively, a composite anode layer may comprise of core-shell structures comprising a variety of active anode materials, preferably, silicon, graphite, or lithium powder.

A composite anode layer may comprise of core-shell structures all of the same shell material, preferably with the general formula Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

Alternatively, a composite anode layer may comprise of core-shell structures of varying shell materials.

A composite anode layer may be formed onto a negative current collector. A negative current collector may include, for example, copper foil, stainless steel foil, etc.

A composite anode layer may include an electronically conductive additive such as, for example, graphene, reduced graphene oxide, carbon nanotubes, carbon black, vapor grown carbon fibers, Super P, acetylene black, carbon nanofibers, etc. Alternatively, an electronically conductive additive may include an electronically conductive polymer such as, for example, polyaniline, polypyrrole, poly(3,4-ethylenedioxythiophene (PEDOT), polyphenylene vinylene etc.

A composite anode layer may include a polymer binder or binder agent to bind it to the negative current collector.

In an alternative, a composite anode layer may be substituted with a metal or metal alloy film such as, for example, lithium metal or lithium metal alloy films, laminated onto a negative current collector in what is referred to in the art as a solid-state lithium metal battery. In such an instance, the composite cathode layer is expected to comprise of core-shell structures.

In another alternative, a solid-state battery may be devoid of a composite anode or metal layer in what is referred to in the art as an anodeless or lithium-free solid-state battery. In such an instance, the composite cathode layer is expected to comprise of core-shell structures.

The present description relates to a solid-state electrolyte layer.

A solid-state electrolyte layer may be composed of a solid-state ionic conductive material.

A solid-state ionic conductive material is a type of material that can selectively allow a specific charged element to pass through under a presence of an electric field or chemical potential, such as concentration differences.

While this solid-state ionic conductive material allows ions to migrate through, it may not allow electrons to pass easily.

The ions may carry 1, 2, 3, 4, or more positive charges. Examples of the charged ions include for example H⁺, Li⁺, Na⁺, K⁺, Ag⁺, Mg²⁺, Zn²⁺, Al³⁺, Fe³⁺, etc.

The ionic conductivity of the corresponding ions is preferably to be >10⁻⁷ S/cm. It is preferable to have lower electronic conductivity (<10⁻⁷ S/cm).

A solid-state ionic conductive material may include, preferably, argyrodite with the general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

Alternative examples of a solid-state ionic conductive material include, for instance, a garnet-like structure oxide material with the general formula:

Liₙ[A_{(3-a′-a″)}A′(a′)A″(a″)][B_{(2-b′-b″)}B′(b′)B″(b″)][C′(c′)C″(c″)]O₁₂,
a. where A, A′, and A″ stand for a dodecahedral position of the crystal structure, i. where A stands for one or more trivalent rare earth elements, ii. where A′ stands for one or more alkaline earth elements, iii. where A″ stands for one or more alkaline metal elements other than Li, and iv. wherein 0≤a′≤2 and 0≤a″≤1;
b. where B, B′, and B″ stand for an octahedral position of the crystal structure, i. where B stands for one or more tetravalent elements, ii. where B′ stands for one or more pentavalent elements, iii. where B″ stands for one or more hexavalent elements, and iv. wherein 0≤b′, 0≤b″, and b′+b″≤2;
c. where C′ and C″ stand for a tetrahedral position of the crystal structure, i. where C′ stands for one or more of Al, Ga, and boron, ii. where C″ stands for one or more of Si and Ge, and iii. wherein 0≤c′≤0.5 and 0≤c″≤0.4; and
d. wherein n=7+a′+2·a″−b′−2·b″−3·c′−4·c″ and 4.5≤n≤7.5.

In another example, a solid-state ionic conductive material includes perovskite-type oxides such as (Li,La)TiO₃ or doped or replaced compounds.

In yet another example, a solid-state ionic conductive material includes NASICON-structured lithium conductor, such as LAGP (Li₁₋ₓAlₓGe₂₋ₓ(PO₄)₃), LATP (Li₁₊ₓAlₓTi₂₋ₓ(PO₄)₃) and these materials with other elements doped therein.

In yet another example, a solid-state ionic conductive material includes anti-perovskite structure materials and their derivatives, such as the composition of Li₃OCl, Li₃OBr, and Li₃OI.

In yet another example, a solid-state ionic conductive material includes the Li₃YH₆ (H=F, Cl, Br, I) family of materials, Y can be replaced by other rare earth elements.

In yet another example, a solid-state ionic conductive material includes Li₂ₓS_{x+w+5z}M_{y}P_{2z}, where x is 8-16, y is 0.1-6, w is 0.1-15, z is 0.1-3, and M is selected from the group consisting of lanthanides, Group 3, Group 4, Group 5, Group 6, Group 7, Group 8, Group 9, Group 12, Group 13, and Group 14 atoms, and combinations thereof.

In yet another example, a solid-state ionic conductive material includes argyrodites materials the general formula: Li₁₈₋₂ₘ₋ₓ(M₂^{m+}Y₇²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in the range of 0≤x≤2.

In yet another example, a solid-state ionic conductive material includes alkali metal halides with the general formula AₐM_{b}^{m+}M′_{b′}^{m′+}X_{a+mb+m′b′}, where A=Li⁺, Na⁺, K⁺, or a combination thereof, X⁻=F⁻, Cl⁻, Br⁻, I⁻, or a combination thereof, M^{m+}=Ti²⁺, V²⁺, Cr²⁺, Mn²⁺, Fe²⁺, Co²⁺, Ni²⁺, Cu²⁺, Zn²⁺, Cd²⁺, Mg²⁺, Pb²⁺, Y³⁺, Sc³⁺, Lu³⁺, La³⁺, Al³⁺, Ga³⁺, In³⁺, Er³⁺, Ho³⁺, Ti³⁺, Cr³⁺, V³⁺, Hf⁴⁺, Zr⁴⁺, V⁴⁺, Ti⁴⁺, Mo⁴⁺, W⁴⁺, V⁵⁺, Nb⁵⁺, Ta⁵⁺, Cr⁶⁺, Mo⁶⁺, W⁶⁺, etc., and M′^{m+} may be metal with the same valance state as M^{m+} when b′ is greater than 0, or an aliovalent substitution when b′ is greater than 0.

A solid-state electrolyte layer may be composed of a solid-state ionic conductive material and a polymer or binding agent, forming what is commonly referred to in the art as a ceramic-polymer composite solid-state electrolyte layer.

Alternatively, a solid-state electrolyte may be composed of an ionically conductive polymer such as, for example, polyethylene glycol, polyethylene oxide, polyvinylidene fluoride, etc. An ionically conductive polymer may further comprise of an ionically conductive salt.

An example of an ionically conducting salt may include, for example, lithium bis(trifluoromethanesulfonyl)imide (LiTFSI) and lithium bis(fluorosulfonyl)imide (LiFSI), lithium bis(oxalato)borate (LiBOB), lithium Difluro(oxalato)borate (LiDFOB), LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂), LiNO₃, sodium bis(trifluoromethanesulfonyl)imide (NaTFSI) and sodium bis(fluorosulfonyl)imide (NaFSI), sodium bis(oxalato)borate (NaBOB) Sodium-difluoro(oxalato)borate (NaDFOB), NaSCN, NaBr, NaI, NaCl, NaAsF₆, NaSO₃CF₃, NaSO₃CH₃, NaBF₄, NaPF₆, NaN(SO₂F)₂, NaClO₄, NaN(SO₂CF₃)₂, NaNO₃, magnesium bis(trifluoromethanesulfonyl)imide (Mg(TFSI)₂) and magnesium bis(fluorosulfonyl)imide (Mg(FSI)₂), magnesium bis(oxalato)borate (Mg(BOB)₂), magnesium Difluro(oxalato)borate (Mg(DFOB)₂), Mg(SCN)₂, MgBr₂, MgI₂, Mg(ClO₄)₂, Mg(AsF₆)₂, Mg(SO₃CF₃)₂, Mg(SO₃CH₃)₂, Mg(BF₄)₂, Mg(PF₆)₂, Mg(NO₃)₂, Mg(CH₃COOH)₂, potassium bis(trifluoromethanesulfonyl)imide (KTFSI) and potassium bis(fluorosulfonyl)imide (KFSI), potassium bis(oxalato)borate (KBOB), potassium Difluro(oxalato)borate (KDFOB), KSCN, KBr, KI, KCl, KClO₄, KAsF₆, KSO₃CF₃, KSO₃CH₃, KBF₄, KB(Ph)₄, KPF₆, KC(SO₂CF₃)₃, KN(SO₂CF₃)₂), KNO₃, Al(NO₃)₂, AlCl₃, Al₂(SO₄)₃, AlBr₃, AlI₃, AlN, AlSCN, Al(ClO₄)₃.

In yet another alternative a solid-state electrolyte may be composed of a single-ion conducting polymer.

A solid-state battery may further comprise of a small amount of liquid electrolyte to enhance ionic mobility at the interface in what is commonly referred to in the art as a hybrid or quasi solid-state battery.

The present description relates to advantages of using core-shell structures in solid-state batteries.

Core-shell structures may enhance contact between the active core and solid-state ionic conductive shell reducing interface impedance enabling higher power rates in solid-state batteries.

Core-shell structures may be sub-micron in size reducing lithium diffusion kinetics and further enabling higher-power rates in solid-state batteries.

The architecture of the core-shell structure may compensate or accommodate the volume change of the active core material during lithium insertion/extraction preventing material contact loss and enhancing cycle life of solid-state batteries.

Core-shell structures may enable a lower stack pressure requirement for solid-state battery operation.

The drawings of the present disclosure further describe the continuous manufacturing process, the core-shell structure, and solid-state batteries comprising core-shell structures.

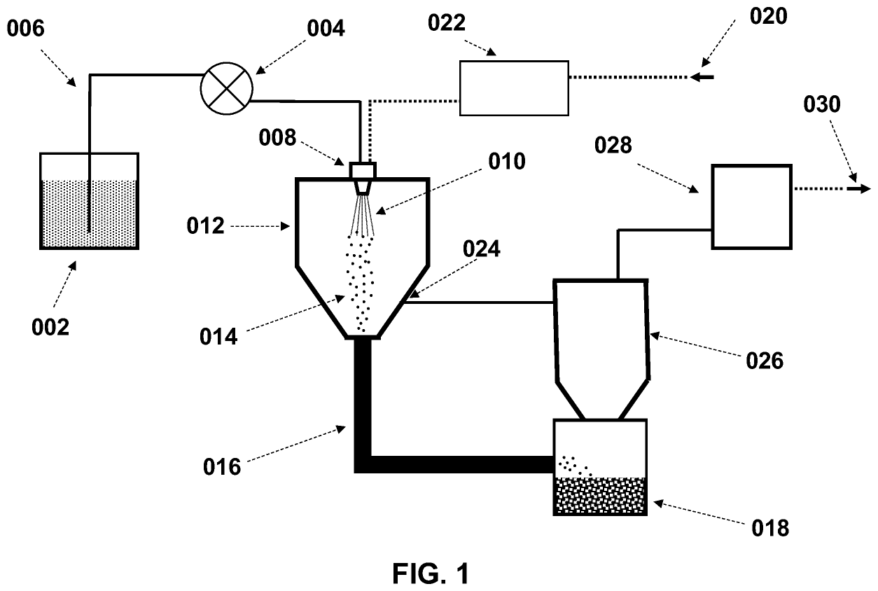

FIG. 1. A schematic representation of a continuous core-shell manufacturing process, wherein a feedstock slurry (002) may be pumped (004) through a feeding line (006) and into a spray nozzle (008) comprising a nebulizer. The nebulized mist (010) may then be sprayed into a high-temperature drying chamber (012) to form the core-shell structures (014) which are then passed through a collection line (016) and into a collection chamber (018). The dry chamber may be under an inert environment using hot inert gas (020) passed through a heating system (022). The inert gas, along with unreacted precursors and fine core-shell structures, may be pushed out through an air outlet (024) and into a cyclone separator (026) which is used to classify the fine core-shell structures wherein they are collected in the collection chamber (018). Inert gas may then be pushed into a filter (028) to collect unreacted precursors and ultra-fine particles and exhausted out (030).

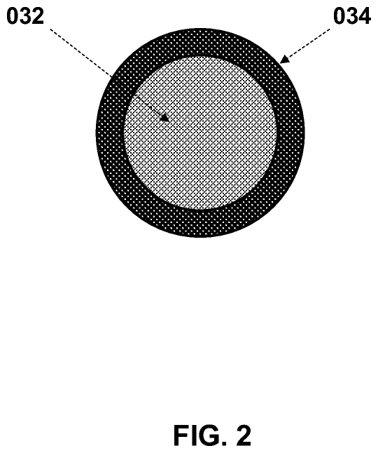

FIG. 2. A schematic representation of a core shell structure comprising an active core material (032) and a solid-state ionic conductive shell (034).

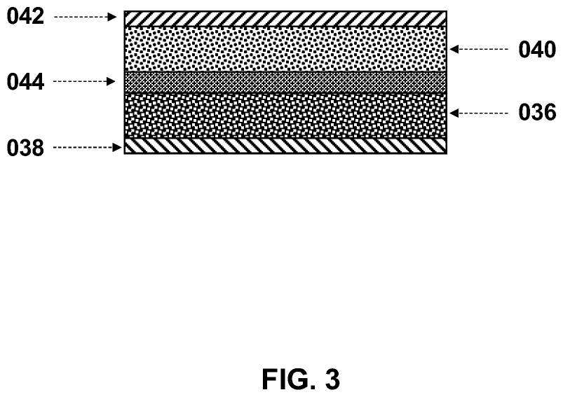

FIG. 3. A schematic representation of a solid-state battery comprising core-shell structures. A solid-state battery may comprise of a composite cathode layer (036), comprising of core-shell structures comprising of an active cathode core, formed onto a positive current collector (038). A solid-state battery may further comprise of a composite anode layer (040), comprising of core-shell structures compromising of an active anode core, formed onto a negative current collector (042). Composite cathode and anode layers may be separated by a solid-state electrolyte layer (044).

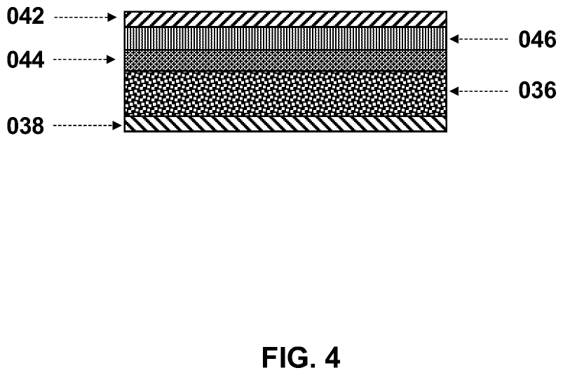

FIG. 4. A schematic representation of a solid-state lithium metal battery comprising core-shell structures. A solid-state lithium metal battery may comprise of a composite cathode layer (036), comprising of core-shell structures comprising of an active cathode core, formed onto a positive current collector (038). A solid-state lithium metal battery may further comprise of a metal or metal alloy film (046) laminated onto a negative current collector (042). Composite cathode and metal layers may be separated by a solid-state electrolyte layer (044).

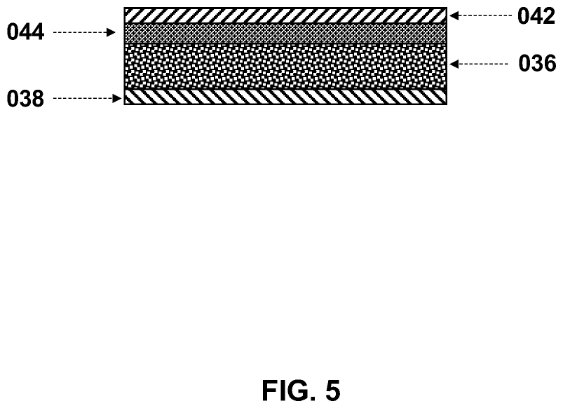

FIG. 5. A schematic representation of an anodeless or lithium-free solid-state battery comprising core-shell structures. An anodeless or lithium-free solid-state battery may comprise of a composite cathode layer (036), comprising of core-shell structures comprising of an active cathode core, formed onto a positive current collector (038). An anodeless or lithium-free solid-state battery may further comprise of a negative current collector (042). Composite cathode layer and the negative current collector may be separated by a solid-state electrolyte layer (044).

The above-describes system and methods can be ascribed to secondary batteries including, for example, solid-state batteries, hybrid solid-state batteries, semi-hybrid solid-state batteries, lithium metal batteries, hybrid lithium metal batteries, semi-hybrid lithium metal batteries, anodeless batteries, anodeless lithium metal batteries, hybrid anodeless lithium metal batteries, semi-hybrid anodeless lithium metal batteries, lithium air batteries, lithium primary batteries, microbatteries, thin film batteries, lithium sulfur batteries, etc.

The above-described systems and methods can be ascribed to various solid-state battery designs such as, but not limited to, pouch cell, coil cell, button cell, cylindrical cell, prismatic cell, etc.

The above-described systems and methods can be ascribed to solid-state batteries with the end use applications such as, but not limited to, electric vehicles, hybrid electric vehicles, mobile devices, handheld electronics, consumer electronics, medical, medical wearables, and wearables for portable energy storage.

The above-described systems and methods can be ascribed to solid-state batteries for grid-scale energy storage backup systems.

The above-described systems and methods can be ascribed to solid-state batteries for longevity, higher energy density and power density, and improved safety.

The above-described systems and methods can be ascribed for alternative energy storage technologies such as primary solid-state batteries and solid-state flow batteries.

The above-described systems and methods can be used in locations other than the vicinity of Earth including in space, such as space stations, satellites, both natural and unnatural, and other planetary bodies such as Mars.

The above-described systems and methods can be ascribed to non-battery applications such as upstream lithium mining or downstream spent battery recycling, wherein a composite solid-state electrolyte layer, comprising the core-shell structures, is used to extract lithium from a lithium-containing solution such as brine or spent battery waste.

In an embodiment of an upstream lithium mining application, a composite solid-state electrolyte layer containing the core-shell structures may be employed to selectively extract lithium ions from a lithium-rich brine. The brine may be obtained from various sources, such as salt flats, geothermal brine, or oilfield brine. The core-shell structures within the composite solid-state electrolyte layer may facilitate the selective transport of lithium ions through the layer, while preventing the passage of other ions, such as sodium, magnesium, and potassium, thereby achieving a higher purity lithium concentrate.

The extraction process may involve providing a composite solid-state electrolyte layer, comprising the core-shell structures, and contacting the layer with the lithium-containing solution. The lithium ions within the solution may selectively interact with the core-shell structures, passing through the solid-state electrolyte layer while other ions remain in the solution. The extracted lithium ions may then be collected on the opposite side of the layer, forming a lithium concentrate.

In another embodiment, the extraction process may include applying an electric field or voltage across the composite solid-state electrolyte layer to enhance lithium ion transport through the layer. The electric field or voltage may create an electromotive force that drives lithium ions through the solid-state electrolyte layer, increasing the extraction efficiency and reducing the overall processing time.

In a downstream spent battery recycling application, the composite solid-state electrolyte layer containing the core-shell structures may be used to extract lithium from waste material generated during the battery recycling process. The spent battery waste may include a mixture of lithium salts, electrolytes, and other metal compounds. The extraction process may involve contacting the spent battery waste with the composite solid-state electrolyte layer, which selectively transports lithium ions through the layer, separating them from other metal ions and impurities.

The lithium extraction method using the composite solid-state electrolyte layer containing the core-shell structures may offer advantages over conventional methods, such as solvent extraction or precipitation, in terms of improved selectivity, efficiency, and reduced environmental impact. By employing the core-shell structures within the solid-state electrolyte layer, lithium ions can be selectively extracted and concentrated, leading to reduced energy consumption, lower processing costs, and minimized waste generation.

In the drawings, the following reference numbers are noted:
002 Slurry feedstock
004 Pump
006 Feeding line
008 Spray nozzle
010 Nebulized mist
012 High-temperature drying chamber
014 Core-shell structures
016 Collection line
018 Collection chamber
020 Inert gas
022 Gas heating system
024 Air outlet
026 Cyclone separator
028 Filter
030 Exhausted gas
032 Active core material
034 Solid-state ionic conductive shell
036 Composite cathode layer
038 Positive current collector
040 Composite anode layer
042 Negative current collector
044 Solid-state electrolyte layer
046 Metal or metal alloy film

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention.

It is to be understood that the invention is not limited to the particular embodiments described herein, as variations and modifications may be made without departing from the scope and spirit of the invention. For example, features described in relation to one embodiment may be combined with features described in relation to another embodiment. Furthermore, additional embodiments may be apparent to those skilled in the art, and such embodiments are also considered to be within the scope of the invention.

In the descriptions provided herein, numerous specific details are set forth to provide a thorough understanding of the embodiments. However, those skilled in the art will recognize that the embodiments can be practiced without one or more of the specific details, or with other methods, components, materials, etc. In other instances, well-known structures, materials, or operations are not shown or described in detail to avoid obscuring aspects of the embodiments. It is understood that the invention may include other combinations and/or uses of one or more specific features or aspects, or combinations and/or uses of other disclosed features or aspects. Moreover, the terms and expressions employed herein have been used as terms of description and not of limitation, and there is no intention in the use of such terms and expressions of excluding any equivalents of the features shown and described or portions thereof, but it is recognized that various modifications are possible within the scope of the invention.

What is claimed is:

1. A method for manufacturing a core-shell material, the method comprising:
atomizing a feedstock comprising a mixture of an active material and a solid-state ionic conductive material, or precursors thereof; and
drying the atomized feedstock to form a core-shell material, the core-shell material comprising a core comprising the active material; and a coating of the solid-state ionic conductive material on the core to form a shell in intimate contact with the core.

2. A core-shell material, comprising: a core comprising an active material; and a coating of a solid-state ionic conductive material on the core to form a shell in intimate contact with the core.

3. The core-shell material of claim 2, wherein the active material includes an active cathode material or an active anode material.

4. The core-shell material of claim 2, wherein the active material comprises at least one of a metal oxide, a metal sulfide, or a metal phosphate.

5. The core-shell material of claim 2, wherein the active materials has a general formula LiNiₓCo_{y}Mn_{z}O₂, where x is in the range of 0.99≥x≥0.1, y is in a range of 0.3≥y≥0.005, and z is in the range of 0.2≥z≥0.005.

6. The core-shell material of claim 2, wherein the active material comprises at least one of lithium, silicon, tin, and carbon.

7. The core-shell material of claim 2, wherein the shell comprises at least one of a solid-state ionic conductive ceramic, a solid-state ionic conductive glass, and a solid-state ionic conductive glass-ceramic.

8. The core-shell material of claim 2, wherein the shell comprises a solid-state ionic conductive material with a general formula: Li₁₂₋ₘ₋ₓ(MₘY₄²⁻)Y₂₋ₓ²⁻Xₓ⁻, wherein M^{m+}=B³⁺, Ga³⁺, Sb³⁺, Si⁴⁺, Ge⁴⁺, P⁵⁺, As⁵⁺, or a combination thereof; Y²⁻=O²⁻, S²⁻, Se²⁻, Te²⁻, or a combination thereof; X⁻=F⁻, Cl⁻, Br⁻, I⁻, or a combination thereof; and x is in a range of 0≤x≤2.

9. The core-shell material of claim 2, wherein the core further comprises a protective layer on the active material.

10. The core-shell material of claim 9, wherein the protective layer comprises at least one of lithium borate, lithium aluminate (LiAlO₂), lithium tungstate (Li₂WO₄), lithium niobium oxide (LiNbO₃), lithium phosphate (Li₃PO₄), lithium oxysulfide (LiAlSO, Li₃PO₄—Li₂S—SiS₂), and lithium oxynitride (LiPON).

11. The core-shell material of claim 2, wherein the core is partially or fully encapsulated by the shell.

12. The core-shell material of claim 2, wherein the active material has an average core size in a range of 1≤d≤100,000 nm.

13. The core-shell material of claim 2, wherein the shell as an average thickness in a range of 1≤t≤100,000 nm.

14. The core-shell material of claim 2, wherein the shell has a thickness (t) and the core has a size (d), and wherein a thickness-to-core size ratio (R) defined as the thickness (t) divided by the size (d) is in a range of 0.000001≤R≤100,000.

15. A method for manufacturing core-shell materials wherein a core comprises an active battery material and a shell comprises a solid-state ionic conductive material, the method comprising:
providing a feedstock comprising a solvent, active battery materials, and dissolved precursors used to form the shell comprising the solid-state ionic conductive material;
pumping the feedstock through a feeding line and into a shower head or spray nozzle comprising a nebulizer;
atomizing the feedstock into a fine mist using a pressurized high-temperature inert gas delivered to the shower head or spray nozzle and the nebulizer;
spraying the fine mist into a high-temperature drying chamber at a temperature in a range of 50≤T≤2000° C.;
coating the precursors onto the active battery materials while evaporating and removing the solvent from the drying chamber;
annealing the precursors to form a solid-state ionic conductive shell in intimate contact with the active battery material core; and
removing the core-shell materials from the drying chamber.

16. The method of claim 15, wherein the solvent comprises ethyl acetate, propyl acetate, isopropyl acetate, butyl acetate, tetrahydrofuran, acetonitrile, hydrazine, methanol, ethanol, propanol, hexane, cyclohexane, toluene, xylenes, etc., or a mixture thereof.

17. The method of claim 15, wherein the active core material comprises at least one of a metal oxide, a metal sulfide, or a metal phosphate.

18. The method of claim 15, wherein the precursors include an inorganic compound with a general formula A₂Y where A is Li, Na, K, Cs, or Rb, and Y is S, Se, or Te, an alkali-metal halide salt with a general formula AX where A is Li, Na, K, Cs, or Rb, and X is F, Cl, Br, or I, and an inorganic compound with an empirical formula M_{y}^{m+}Yₘ^{y-} where M^{m+} is B³⁺, Ga³⁺, Sb³⁺, Si⁴⁺, Ge⁴⁺, Sn⁴⁺, P⁵⁺ or As⁵⁺ and Y^{y-} is S²⁻, Se²⁻, or Te²⁻.

19. The method of claim 15, wherein the core further comprises a protective layer on the active material.

20. A solid-state battery comprising a cathode layer comprising core-shell materials, wherein the core-shell materials comprise an active cathode core and a solid-state ionic conductive shell, wherein the core-shell structure has a thickness-to-core size ratio (R) defined as the shell thickness (t) divided by the core size (d) in the range of 0.000001≤R≤100,000.

21. The battery of claim 20, wherein the solid-state battery comprises an anode layer further comprising core-shell materials, wherein the core-shell materials comprise an active anode core and a solid-state ionic conductive shell, wherein the core-shell structure has a thickness-to-core size ratio (R) defined as the shell thickness (t) divided by the core size (d) in the range of 0.000001≤R≤100,000.
